(19) United States
(12) Patent Application Publication
(10) Pub. No.: US 2026/0138020 A1
(43) Pub. Date: May 21, 2026

(54) ROUTE-BASED STORY CREATION AND AI DRIVEN GAME FOR IN-VEHICLE DISPLAY

(71) Applicant: Sony Interactive Entertainment Inc., Tokyo (JP)

(72) Inventors: Michael Padilla, San Mateo, CA (US); Sankalp Mohanty, San Mateo, CA (US); Richard Solano, San Mateo, CA (US)

(21) Appl. No.: 18/954,907

(22) Filed: Nov. 21, 2024

(51) Int. Cl. A63F 13/54; A63F 13/215; A63F 13/216; A63F 13/65; G06F 40/20

(52) U.S. Cl. CPC A63F 13/54; A63F 13/215; A63F 13/216; A63F 13/65; G06F 40/20

(57) ABSTRACT

Interactive route-based media may be generated using generative artificial intelligence (AI) models so that electronic games can be played by passengers in a vehicle while the driver safely navigates to a destination. Audio may still be presented to the driver in certain instances, while video of the game can be presented on passenger vehicle displays integrated into the vehicle's side windows. Large language models and other generative AI models may therefore be used to create the game content itself, with the game content being generated based on various inputs to the system like a user's desired game genre, geographic features encountered along the driving route, and even the driving range of the vehicle according to a current fuel or charge level. Each AI-generated game can be tailored to the route the vehicle is going to take, presenting interactive game content that accounts for the unique characteristics of the trip.

### FIELD

The disclosure below relates to technically inventive, non-routine solutions that are necessarily rooted in computer technology and that produce concrete technical improvements. In particular, the disclosure below relates to route-based story creation and AI-driven games for in-vehicle display.

### BACKGROUND

Vehicle hardware is becoming increasingly sophisticated, including in the integration of transparent displays into the windows of the vehicle. However, as recognized herein, vehicle software still leaves much to be desired and does not optimize use of this hardware. Accordingly, no adequate solutions currently exist to the foregoing computer-related, technological problem.

### SUMMARY

Present principles advantageously enable use of LLMs and other artificial intelligence (AI) models to generate route-based, story-driven games for people to play in a vehicle while driving along a route to a destination. Present principles do so in a safe manner to minimize distracted driving, including presenting only audio to the driver of the vehicle while passengers are additionally presented with video on displays integrated into the side windows of the vehicle (and/or on secondary screens such as individual smartphone displays). The AI models may use vehicle type, fuel range (e.g., gas stops needed), vehicle stats, route start and end locations, key points along the route, vehicle environment (e.g., vehicle speed, traffic, weather) and still other data to determine the storyline for the game.

Accordingly, in one aspect an apparatus includes at least one processor system configured to access first data related to navigation from a first geolocation to a second geolocation. The at least one processor system is also configured to provide the first data to a large language model (LLM) along with a prompt to generate a storyline using the first data. The at least one processor system is also configured to receive, from the LLM, an output indicating the storyline. The at least one processor system is then configured to present audio related to the storyline via a vehicle's audio system.

In various example implementations, the storyline may be an interactive storyline. Thus, the at least one processor system may be configured to receive first audible input and to present, based on the first audible input, a first aspect of the storyline as part of the audio. The at least one processor system may be further configured to receive second audible input and to present, based on the second audible input, a second aspect of the storyline as part of the audio. The second aspect may be different from the first aspect. The second aspect may be presented as part of the audio instead of a third aspect of the storyline that is also indicated in the output from the LLM. The second aspect of the storyline may thus be presented in the alternative to the third aspect of the storyline based on the substance of the second audible input.

Also in various example implementations, the at least one processor system may be configured to present video related to the storyline via the vehicle's video system. So here, the storyline may be an interactive storyline that is used by the at least one processor system to present both interactive audio and interactive video at the vehicle. If desired, the interactive video may even be presented on one or more displays integrated into respective windows of the vehicle, such as a windshield of the vehicle, a side window of the vehicle, and/or a rear window of the vehicle.

In various example embodiments, the first data may be related to one or more geographic features located along the route from the first geolocation to the second geolocation. Additionally or alternatively, the first data may be related to a fuel range of the vehicle while navigating from the first geolocation to the second geolocation, and/or a charge range of the vehicle while navigating from the first geolocation to the second geolocation. The first data may also be related to forecasted weather along a route from the first geolocation to the second geolocation.

What's more, in some instances the at least one processor system may be configured to receive user input to detour from the route from the first geolocation to the second geolocation. Based on the user input, the at least one processor system may then be configured to change the presentation of the audio related to the storyline.

In another aspect, a method includes accessing first data related to vehicle travel from a first geolocation to a second geolocation. The method also includes providing the first data to a model, and providing a prompt to the model to generate a storyline using the first data. The method further includes receiving, from the model, an output indicating the storyline. The method then includes presenting media related to the storyline via an output device.

In some example embodiments, the model may include a large language model (LLM).

Also in some example embodiments, the output device may include a vehicle audio system and/or a vehicle video system.

Additionally, in various examples the media may be first media that is interactive. Here, the method may then include receiving user input and processing the user input to identify second media that is interactive. The second media may also be related to the storyline. Based on the identification of the second media, the method may then include presenting the second media via the output device.

In still another aspect, an apparatus includes at least one computer readable storage medium (CRSM) that is not a transitory signal. The at least one CRSM includes instructions executable by a processor system to access first data related to vehicle travel from a first geolocation to a second geolocation. The instructions are also executable to provide the first data to a model, and to provide a prompt to the model to generate a storyline using the first data. The instructions are further executable to receive, from the model, an output indicating the storyline. The instructions are then executable to present media related to the storyline via an output device.

In one example, the media may be first media. Here, the instructions may then be executable to receive user input to add a stop to a route being traversed by the vehicle, with the route being from the first geographic location to the second geographic location. The instructions may then be executable to access added content for the storyline based on the user input, and to present second media at the output device. The second media may be related to the added content.

Also in various examples, the media may include interactive audio video content that establishes an electronic game that is playable by passengers in a vehicle in which the media is presented. The output device may thus be established by the vehicle itself in certain non-limiting instances.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIGS. 2 and 3 show example illustrations of a first-person perspective of a driver sitting inside a vehicle while initiating an AI-driven game for in-vehicle play consistent with present principles;

FIGS. 4 and 5 show example illustrations of a vehicle during travel to a destination, with the vehicle presenting game graphics on the windows of the vehicle for the passengers to play an electronic game consistent with present principles;

FIG. 6 shows example logic in example flow chart format that may be executed by an apparatus consistent with present principles;

FIG. 7 shows example artificial intelligence (AI) architecture that may be implemented consistent with present principles;

FIG. 8 shows an example graphical user interface (GUI) that may be presented in the vehicle to configure one or more settings of the game engine to execute consistent with present principles; and

FIG. 9 shows a schematic flowchart of techniques and logic that may be implemented consistent with present principles.

### DETAILED DESCRIPTION

The detailed description below provides technical systems and methods for creating route-based, story-based, AI-driven games for in-vehicle display. Thus, generative AI models may be used to generate a story-driven game using various trips-specific parameters, including vehicle type, fuel range (e.g., gas stops needed from point A to point B), vehicle stats (average miles-per-gallon), start and end locations, key points on the route, environmental metrics (e.g., current vehicle speed, current traffic, current weather), etc.

User customization may also be afforded as well. For example, the driver can choose to be audibly involved in the game safely while driving, while augmented reality (AR) software may be executed to present visual AR content on the transparent displays of side windows of the vehicle (and/or using secondary screens such as Bluetooth-connected smartphone displays). Customization may also relate to which passengers want to play which roles within the game (and/or have some roles assigned at random), whether the games should be more chill or less chill, etc.

Still further, different passengers may concurrently play different AI-driven games on different respective windows of the vehicle, if desired. Directional, binaural 3D audio may also be presented to each passenger through a headset (e.g., earphones) or other stereo speakers. What's more, each passenger's head position may be identified using computer vision and in-vehicle cameras to then identify each user's viewing angle toward a real-world object outside their respective window to then present an AR game object in the user's field of view to visually blend in with the real-world object as if the AR game object is interacting with the real-world object. Additionally or alternatively, AR content may be designed to be located in 3D in the real-world at far-away locations where the different passengers' angles of view to the same AR object would not result in incongruous presentation of game content regardless of which window the AR object is presented on.

But regardless of whether one game or different games are being played concurrently at the same vehicle, each game may be executed by the game engine according to a decision tree provided by one of the AI models during game creation, with the user able to choose different paths in the storyline during gameplay for different aspects of the game to be presented in the alternative to each other according to forks in the decision tree.

Further still, an AI-driven, in-vehicle game consistent with present principles may include embedded content for players of different age levels. For example, an overall storyline that is self-consistent may be presented for players of all age levels, but individual game media may still vary in intellectual complexity with more-mature rated sly jokes and clues for older players being included as “hidden” content.

Still further, in some examples the AI-driven game may be buffered based on unexpected vehicle traffic along the route, in which case added in-game challenges may be presented as additions to the game. Additionally or alternatively, added content in the form of background music may be presented as a pause in the game itself during the traffic.

As an added layer of security, in some implementations all game content, metadata, passenger data, etc. may be deleted after the game concludes to protect the personal information and navigational/location information of the people inside the vehicle that was used to generate the game.

With the foregoing in mind, it is to be understood that this disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

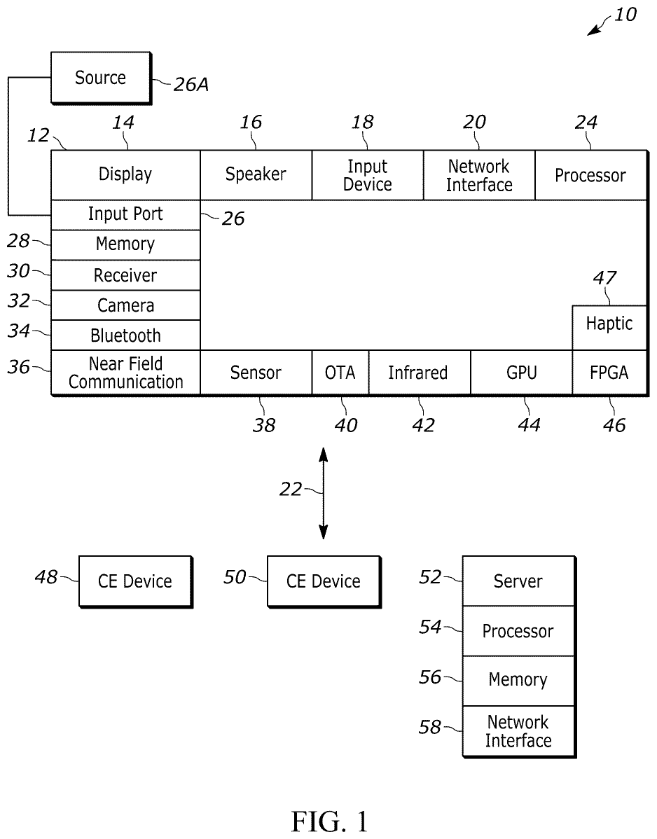

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12 consistent with present principles. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer/video game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player, or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components discussed in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

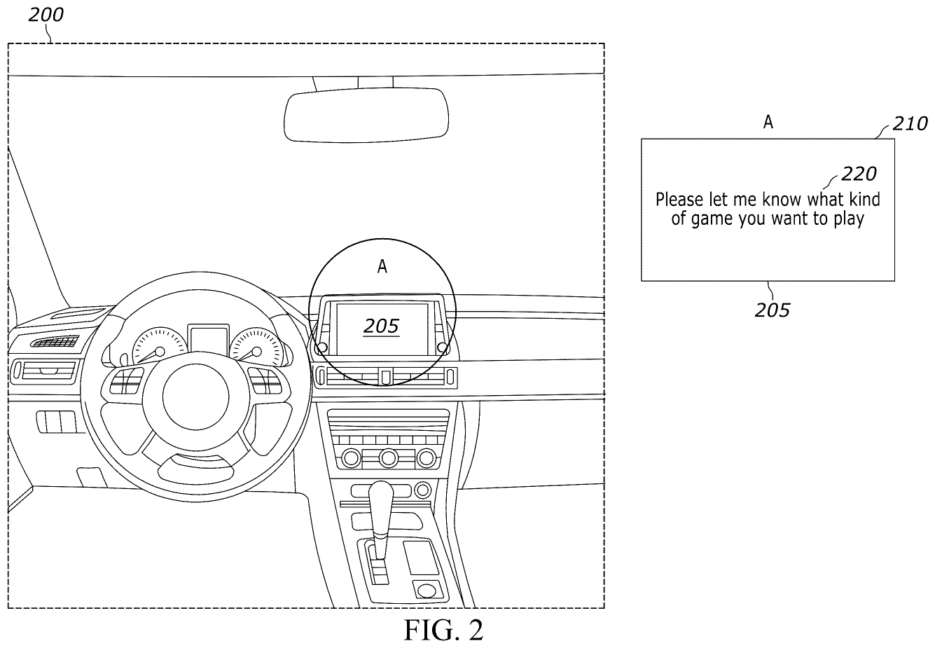

Now in reference to the schematic diagram of FIG. 2, suppose a group of people enter a car or other personal vehicle 200 to embark on a road trip from one geographic location to another. FIG. 2 shows the first-person perspective of the driver while sitting inside the driver's seat of the vehicle before embarking.

Inset A indicates that the video display 205 of the vehicle's entertainment system may present a graphical user interface (GUI) 210. The GUI 210 may include a prompt 220 asking the user to provide input to set forth parameters for an AI-driven game to be dynamically generated on the fly and then presented to the driver and passengers during their road trip. The driver and/or another passenger may then provide audible input specifying their parameters for the game, such as game type, characters to use, max content rating for the content of the game, etc. A voice assistant operating as part of the vehicle's entertainment system may therefore process the audible input as received from an in-vehicle microphone to generate corresponding text using a speech-to-text algorithm. The resulting text may then be passed to a large language model (LLM).

The LLM and/or other AI-based generative models may then be executed to generate an in-vehicle game that conforms to the one or more parameters set forth by the passengers themselves as well as other data, such as time-to-destination, landmarks to be encountered along the route, weather to be encountered along the route, etc. The LLM and other AI models may be executed at a server in one example, with the vehicle's entertainment system communicating with the server over an Internet connection. Other implementations are possible as well, including using a smartphone to receive the user input and communicate with the server such that communications between the vehicle's entertainment system and server are routed through the smartphone.

In terms of the game that is generated, the game may be any number of types, both by game genre as well as output type. For game genre, different games might be chosen including, but not limited to, adventure, action, sports, puzzles, etc. Example output types may include an audio-only game (no video), audio-only interactive game, video-only game (no audio), video-only interactive game, audio-video game, and audio-video interactive game. Non-interactive games may still enable participation in the sense that users can use the game as prompts to do things in the real world and engage with other passengers, but the operative storyline of the game itself does not change based on user responses and instead goes through a preset storyline without deviating. Interactive games may have interactivity in that users may provide input to play the game, which in turn results in the game adjusting to take one of alternate decision tree paths as will be made more apparent below.

What's more, note that game content may be selected based on additional parameters, such as expected length of trip from origin geographic location to destination geographic location (e.g., total mileage and/or driving time). Another example parameter may be current fuel and/or electric charge range of the vehicle such that the game ends, or is scheduled to segue between scenes/levels, at an expected refuel/recharge time. As yet another example, parameters may relate to real-world weather conditions that might be encountered along the route, such as rain, snow, foggy air, etc.

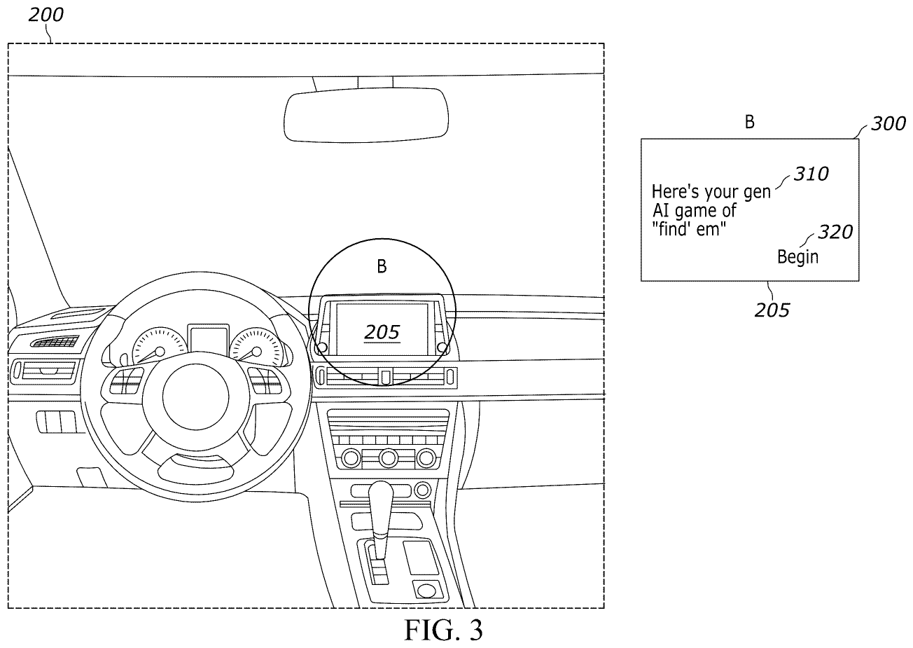

With the foregoing in mind, FIG. 3 illustrates that responsive to the game being generated by the AI system operating in the background, the display 205 may present another GUI 300 at a later time. As shown, the GUI 300 may provide an indication that a generative AI game has been created and auto-titled “Find 'em” based on the example parameters given by the players in this instance. For the present example, assume the parameters included creating a visual “hunting” game where the players look outside of the vehicle to find hidden augmented reality (AR) objects that are virtually embedded in the real-world environment in three dimensions (3D).

Then, to begin the game, the driver or other passengers may provide audible input to “begin”. Alternatively, one of the people may select the “begin” selector 320 that is also presented on the GUI 300.

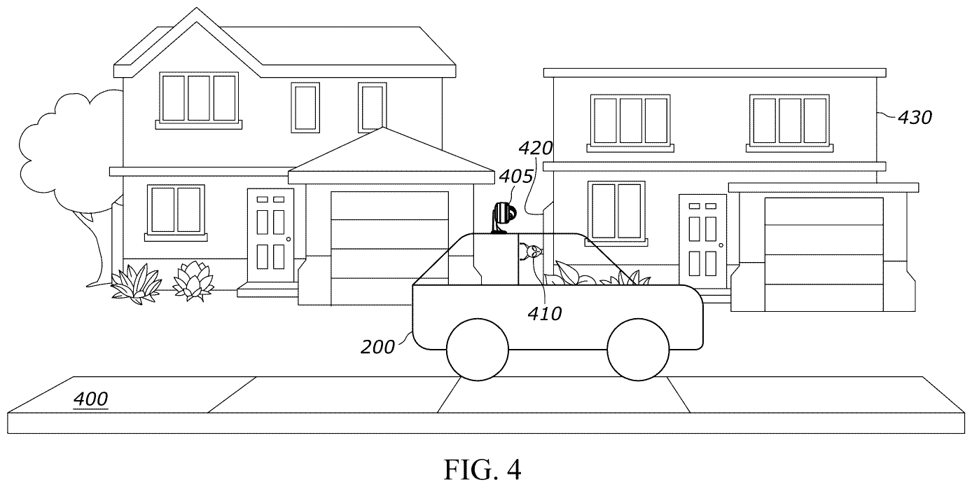

FIG. 4 then illustrates the vehicle 200 embarking on the road trip down a first road 400. As may be appreciated from FIG. 4, the vehicle may have a three hundred sixty degree (360) camera 405 and/or other sensors for the vehicle 200 to track its environment along the way. Note that the actual passengers have been omitted from illustration within the vehicle 200 to demonstrate present principles.

Those principles include presentation of an AR virtual alien 410 superimposed on the internal passengers' views of the external world around the vehicle. This may be done using transparent displays integrated into the windows of the vehicle 200, including the windshield/front window of the vehicle 200, all side windows of the vehicle 200, and the rear/back window of the vehicle 200. As shown in FIG. 2, the head of the alien 410 is peeking around a real-world corner 420 of a real-world house 430 in a residential real-world neighborhood. The alien's body is hidden from the passengers' views and only the head visible. Thus, the passengers may visually scan their real-world environment through the windows (and hence transparent displays) of the vehicle 200 to try to locate the AR alien 410 and then provide audible input describing its 3D location to prove that they have found it. In the present example, the alien 410 is only being presented on a single front left (driver's) side window owing to the alien's 3D anchor in real-world space being at/behind the corner 420.

Therefore, further note here that the camera 405 may be used to identify physical features of real-world objects just ahead of the vehicle 200 to feed those images back to the game engine as executing locally at the vehicle 200 and/or at a connected server. The game engine may then dynamically and visually embed the AR objects of the game into the real-world scene (using AR software and the window displays) according to the features and boundaries of the real-world environment identified from the camera images. Additionally, a given passenger's viewing angle toward the real-world, 3D anchor point for the AR object may be used to embed the AR object into the scene for congruous viewing in AR by that passenger according to his or her angle of view.

Additionally, when one or more passengers give a response to the game indicating a potential location of the alien 410 as indicated above, natural language processing as well as images from the camera 405 may be used to infer whether the audible input corresponds to the real-world 3D location at which the system represented the alien 410. An inferred match may thus be used as a correct game input, while no match of the audible input to features of the alien's location may be used as incorrect game input.

In the present example, correct game input may result in the alien 410 disappearing and the game engine then presenting another AR object for visual discovery at another (later) location along the same driving route. Incorrect game input may result in the alien 410 being repositioned at another 3D real-world location along the route as the vehicle continues to traverse the road 400.

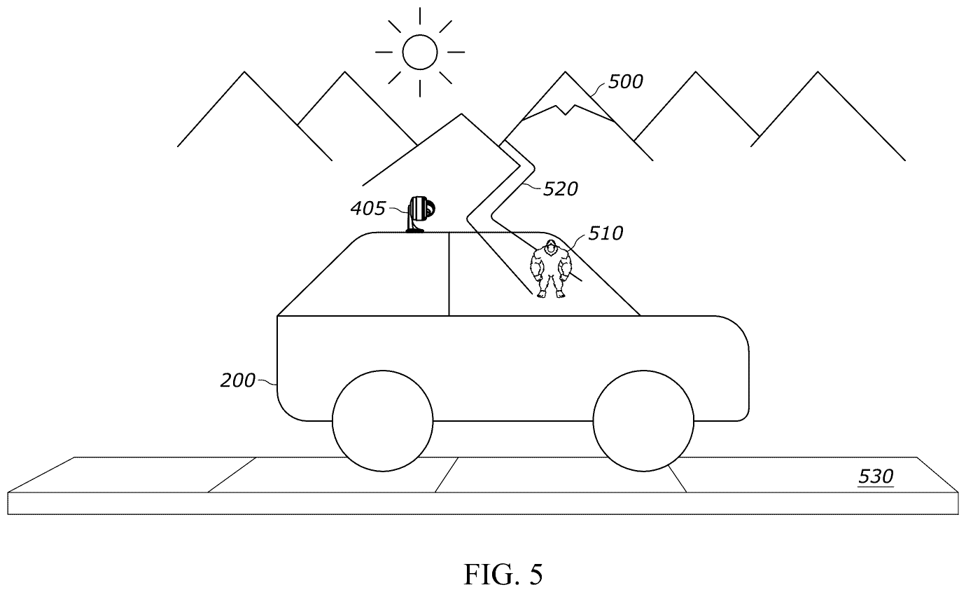

With this in mind, FIG. 5 shows that, at a different point along the route from the vehicle's point of origin to its destination, another AR object may be presented to appear as though also located in the real-world around the vehicle. In the present example, predetermined geographic data from the maps app, and/or images from the camera 405, may be used by the system to determine that, rather than being in a suburb as in FIG. 4, the vehicle 200 is now located in the countryside with mountains 500 in the background. Based on the change in physical scenery type, the game may present an AR miniature yeti 510 to appear as though walking down the real-world mountain road 520 toward the vehicle 200 as the vehicle 200 drives by down a main highway 530 nearby. The passengers may thus continue to hunt for AR objects presented on the various window displays of the vehicle 200, as themed to the physical scenery around the vehicle 200. The AR objects may be classified as matching a given theme of the real-world scenery using a relational database of AR objects and scenery type, based on correlations provided by the storyline-generating LLM, etc.

However, notwithstanding the example of FIGS. 4 and 5 above, further note that AR-driven games consistent with present principles need not necessarily be video-based. To wit, audio-only and audio-video games may also be presented over the vehicle's audio/video entertainment system. For example, audio puzzle games may be presented over vehicle speakers. As another example, the AR objects of FIGS. 3-4 may be presented along with directional (binaural) 3D audio to represent sound from the AR object (e.g., the yeti's roar) as coming from the real-world 3D location at which the AR object itself is represented as located.

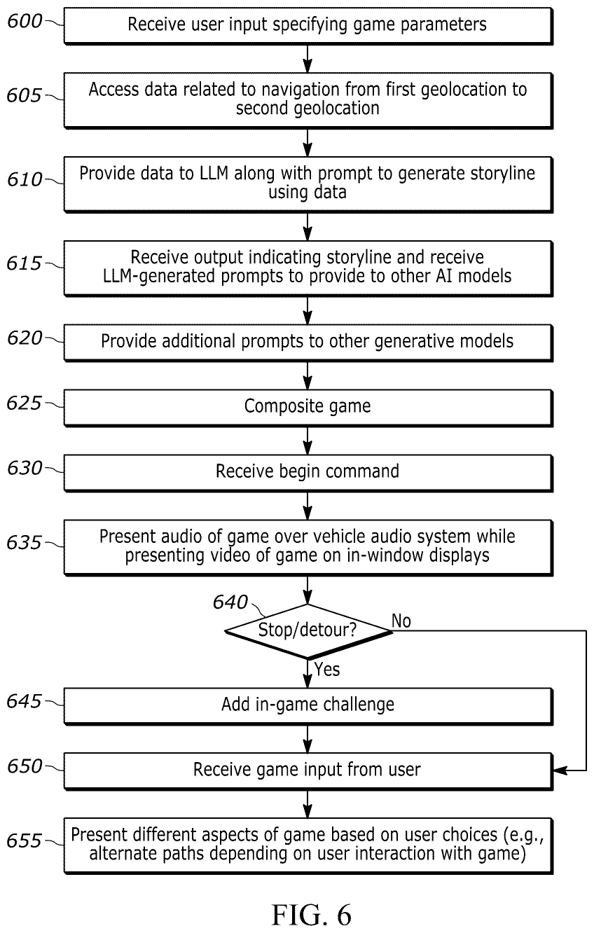

With this in mind, reference is now made to FIG. 6. This figure shows example logic that may be executed by an apparatus such as a client device (vehicle or smartphone) and/or coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 6 is shown in flow chart format, other suitable logic may also be used.

Beginning at block 600, the apparatus may receive user input specifying game parameters for an in-vehicle game that is to be played by vehicle passengers while traveling by car to a destination. The input may be audible input, input to a GUI presented on a connected display, etc. The logic may then proceed to block 605 where the device may access first data related to navigation from the first geographic location (origin) to the second geographic location (destination).

The first data may therefore include the expected travel route, metadata about physical landmarks that will be encountered along the way, metadata about terrain and geological features that will be encountered along the way, etc. The route may be provided by the maps/navigation application that is being executed to provide driving directions to the destination. The landmark and terrain metadata may be identified through the maps application as well, which might indicate landmarks beside the route and types of terrain over which the vehicle will drive as part of the route. Example landmarks include the Statute of Liberty and a famous sports stadium. Example terrain includes hilly pavement, dirt roads, mountain highways, etc. These items may then be used in the new game that is being built (e.g., presenting visual AR objects in relation to those real-world features).

Applicable metadata may be accessed from other places as well. For example, metadata may be identified from a server-based crowdsource database that stores images from previous vehicles that traversed the same segment of roadway earlier in the same day. Object identification may then be executed on those images to identify real-world objects to use in the new game that is being built for the vehicle 200.

As one specific example, a structure identified as a decrepit house from images generated earlier in the day by a different vehicle may be inferred as an appropriate place to visually “hide” an AR zombie during a visual “hunt” game when the vehicle 200 drives by the same location later on. Or an open door of the decrepit house may be inferred as remaining open for at least a threshold period of time (e.g., five more minutes) based on images from another vehicle that passed by the house close in time also showing the open door.

Thus, it is to be understood more generally that the first data that is accessed at block 605 may include data received or fetched from other devices and applications (“apps”), including not just landmark data and geographic features (e.g., mountains, city streets, terrain and elevation information, etc.) but also other types of data. Those other types of data may include current fuel range and/or current electric charge range of the vehicle while navigating the route, forecasted weather along the route, and still other parameters including those set forth elsewhere herein.

Also note in terms of landmarks and geographic features that these items may be used for incorporation into other aspects of game execution as well. For example, mountainous and inconsistent terrain may be used to adjust AR content presentation to remain anchored in 3D in the real world notwithstanding physical vehicle movement. Landmarks and geographic features may also be used for selecting different types of game content to use based on the content itself being correlated to a theme or characteristic of the landmark or geographic feature. And notwithstanding the examples above, landmarks may include any number of different things, including not just historical landmarks but also restaurants, parks, shopping centers, etc.

Regarding fuel/charge range, the game may be preconfigured to take scheduled breaks, or segue between game scenes or stages, at expected mileage markers along the route that are just before the current fuel/charge range of the vehicle is estimated to run out. In this way, when the users stop to refuel or recharge the vehicle, the game may be paused at a natural break point in the game rather than right in the middle of a particular in-game task.

Regarding forecasted weather, expected weather can be used for determining types of content to include in the game so that the game advantageously merges with the passengers' perception of the real-world weather environment. For example, in rainy weather, a visual AR object may be represented as wet, while in snowy weather a visual AR object may be represented as covered in snow. Weather may also be used with interactive features of a game, such as rainy or snowy weather impacting traction control in a racing simulation game to cause a virtual race vehicle (as presented on a side window display) to lose traction more easily than later in the game when the real-world vehicle itself is back on a dry driving surface.

Still in reference to FIG. 6, from block 605 the logic may then proceed to block 610. At block 610 the apparatus may provide the first data to a first large language model (LLM) and/or other natural language processing model. The apparatus may also provide, to the first LLM, a prompt to generate a storyline for an AI-driven game using the first data. Note that the prompt may include and/or be based on user input of certain parameters as set forth above (e.g., desired game genre), but may also include additional text not provided by the end-users such as explicit instructions to write game code for the game itself.

From block 610 the logic may then proceed to block 615. At block 615 the apparatus may receive an output from the first LLM indicating a generative storyline inferred by the first LLM using the parameters and data it was provided. Note here that in some instances, the LLM's output may therefore include one or more decision trees for game interactivity according to alternate game paths that may be taken according to the storyline.

The output from the first LLM may also indicate LLM-generated prompts that the apparatus is to then provide to other generative AI models to help build out the game. The other generative models may include generative text-to-audio models and generative text-to-image models. Example generative audio models include autoregressive transformers and generative adversarial networks, though other types of generative audio models may also be used. Example generative image models include variational autoencoders, generative adversarial networks, and recurrent neural networks, though here too other types of models may be used.

In addition to prompts for generative audio and generative image/video models, the first LLM may also provide an output in the form of a prompt to a generative game code model (e.g., should the game code not be generated by the first LLM itself based on the input provided at block 610). Thus, according to some examples, a separate (second) game code-generating LLM may be provided with a prompt from the first LLM for the second LLM to then generate conforming game code for execution by a game engine. The game code may thus be generated by a dedicated LLM in some examples, with the dedicated LLM being specifically trained to generate game code based on vehicle navigation-related scenarios, parameters, and storylines consistent with present principles. For example, the second LLM may be trained on datasets of one or more parameters and storylines along with ground-truth game code to generate. The training parameters may include any of those set forth above, including user-provided parameters and other parameters such as landmarks, weather, fuel range, etc.

With the prompts from the first LLM having been received at block 615, the logic may then proceed to block 620 where the apparatus may provide those additional prompts to the other respective generative models as set forth above so that each one can generate its corresponding output.

Further note here that the audio and video outputs from the generative audio and video models may not necessarily include complete game content from beginning to end of the game. Instead, those outputs may include individual audio and video object outputs that are generated in response to specific, individualized prompts from the first LLM to generate individual game objects that will then be referenced by the generative game code that gets generated according to the storyline provided by the first LLM.

Moving to block 625, the outputs from the other generative models may then be used to composite together an AI-driven unique video game that is tailored to the trip on which the vehicle passengers are about to embark. Compositing together the game may therefore include storing all generative image and audio outputs at respective storage locations referenced in the generative game code for each one so that the game code can be properly executed by the game engine to present the game content according to the file locations indicated in the code.

In certain circumstances, compositing the game together at block 625 may also include loading an instance of the game, including loading audio and video objects, into non-persistent memory for the game engine to then execute the game code to present the game at the vehicle at step 635 (responsive to receipt of a begin command at block 630). Thus, at block 635 the apparatus may begin presenting various media related to the storyline of the game, including presenting game audio over the vehicle's audio system while concurrently presenting corresponding game video on the transparent vehicle displays of the vehicle's windows. In addition, at the very beginning of the game, the system may present upcoming “objectives” for the game itself as well as real-world pre-planned stopping locations.

From block 635 the logic may then proceed to decision diamond 640. At diamond 640 the apparatus may determine whether a stop has occurred where the vehicle stops along the route, and/or whether a detour has occurred where the vehicle stops taking the pre-planned route and starts traversing another route. These determinations may be made based on input from the maps or navigational assistant app that is executing to provide directions to the destination, for example. An affirmative determination may cause the logic to proceed to block 645, while a negative determination may cause the logic to instead proceed directly to block 650.

Describing block 645 first, note that at this step the apparatus may add an additional, pre-planned in-game challenge for the players to dynamically extend the game with additional play features based on the expected or unexpected stop or detour (and/or any traffic extending the overall length of the trip itself as also indicated by the maps app). For expected stops and detours, such as where the user indicates the stop/detour to the maps app, the system may generate the added content in advance using AI models similar to the process set forth above for the initial storyline, incorporating the added content into the storyline. For unexpected stops and detours, the system may still access pre-generated content, but here the content may not impact the overall storyline of the game.

Either way, note that each added challenge may be its own game within the larger game. As such, and as an example, the added challenge might be to “find” virtual items hidden around the outside of a restaurant where the people are stopping for food, with audio-based location hints being provided to help the people in the side challenge.

Then at block 650 the apparatus may receive game input from one or more users (vehicle passengers) while the game media is played out. This might include audible input processed by a digital assistant, touch input to one of the game displays in the vehicle, etc. The logic may then proceed to block 655 where the apparatus may present different alternative aspects of the game based on the substance of the user's input and the respective matching aspect of the LLM-generated decision tree.

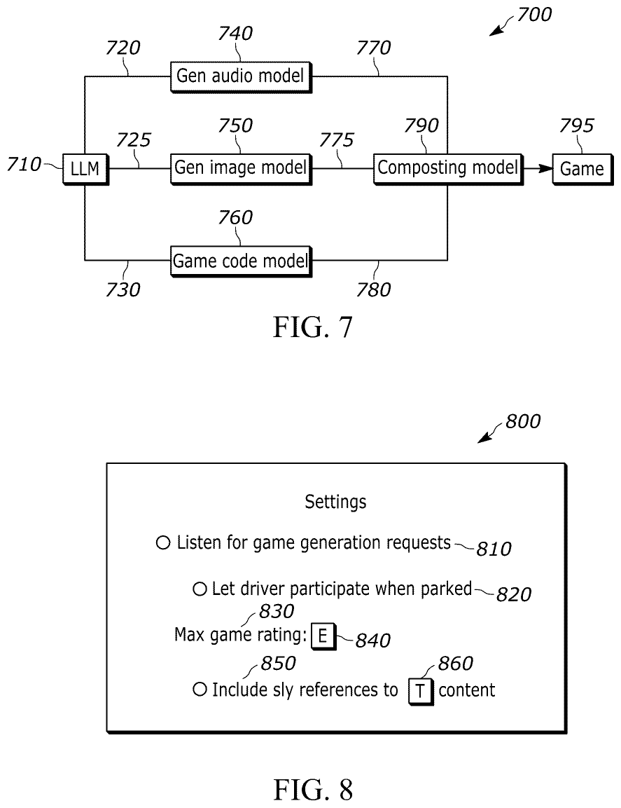

Now in reference to FIG. 7, example artificial intelligence (AI) architecture 700 is shown that may be implemented consistent with present principles. However, the architecture 700 is but an example and other architectures are also encompassed by present principles.

As shown in FIG. 7, the AI architecture 700 may include a large language model (LLM) 710 that may be similar to Gemini, ChatGPT, Llama, etc. Thus, generative pretrained transformers (GPTs) may establish the LLM 710, though other types of language models may also be used. The LLM may therefore process a prompt provided to it as set forth above to then generate outputs 720-730 in the form of respective natural language prompts to respective generative models 740-760. Thus, a prompt 720 to generate game audio according to one or more parameters indicated in the prompt 720 may be provided as input to the generative audio model 740 to generate corresponding game audio. A prompt 725 to generate game video according to one or more parameters indicated in the prompt 725 may be provided as input to the generative video model 750 to generate corresponding game video (including video content to be presented on the window displays of the vehicle).

Additionally, a prompt 730 to generate executable game code according to one or more parameters indicated in the prompt 730 may be provided as input to the generative game code model 750 to generate corresponding executable game code for the vehicle or other device to execute to present the game to the vehicle passengers. The code may be written in C++ or JavaScript, for example.

Note that each of the models 740-760 may be trained on respective datasets of LLM-generated prompts and parameters along with ground truth game outputs (e.g., generative audio, video, and game code). Other machine learning methods may be used as well to train the models 740-760.

Respective generative outputs 770-780 from the models 740-760 may then be provided as input to a compositing model 790, which may be a rules-based or AI-based software module for compositing together the game 795 that is being created. Thus, the model 790 may store the audio and video outputs 770, 775 at file paths indicated in the game code 780 so that the game code 780 can be executed using those media assets as referenced in the code itself.

Continuing the detailed description in reference to FIG. 8, this figure shows an example settings graphical user interface (GUI) 800 that may be presented to configure one or more settings of an apparatus to undertake present principles. The settings GUI 800 may therefore include a first option 810 that may be selected to set or configure the apparatus to listen for audible game generation requests from vehicle passengers in the future, possibly as cued using a wake-up word.

The GUI 800 may also include an option 820. The option 820 may be selected to set or configure the apparatus to let the driver visually participate in a game while the vehicle's transmission is in the parked configuration, thus allowing the driver to fully participate in the game when safe to do so. Notwithstanding, note that the driver may still audibly engage in the game at other times, eyes free for visualizing the road.

FIG. 8 also shows that in some examples, the GUI 800 may include a setting 830 at which a user can enter a max game rating (using ratings entry box 840). Thus, generated game media can be tailored to the sensitivities of some or all passengers in the vehicle, such as having an “everyone” rated game be presented when children are present in the vehicle. However, in certain non-limiting examples the setting 830 may include an option 850 that may be selected to set or configure the apparatus to also include sly references to higher-rated content (up to a max rating entered into ratings entry box 860). Thus, in some examples, adult passengers may be presented with sly jokes and other higher-rated references in covert ways not typically detectable by children. As such, the LLM 710 from above may be trained specifically on legacy children's motion pictures, many of which contain such references which can then be used to train the LLM to generate similar higher-rated outputs as part of the overall game storyline.

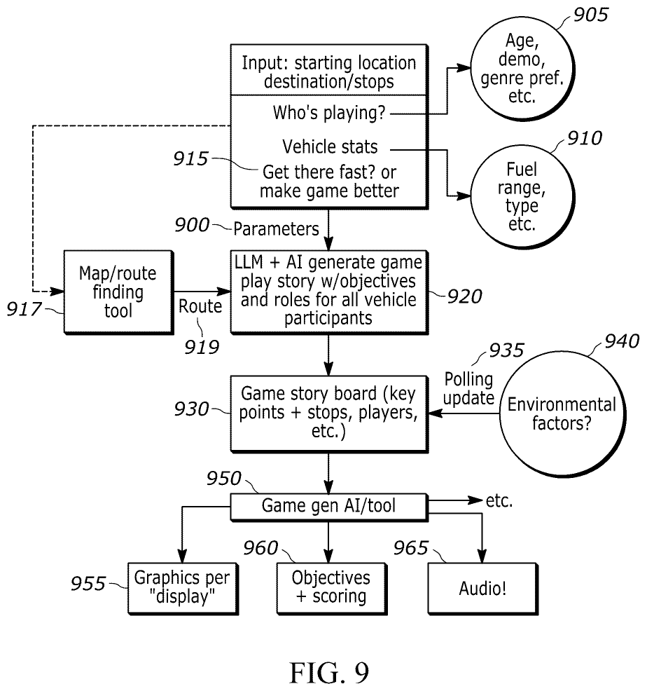

Now in reference to FIG. 9, this figure shows an overall schematic flowchart for techniques and logic that may be implemented consistent with present principles. As shown, inputs 900 may be accessed. The inputs 900 may include a starting geolocation, a destination geolocation, and even user input of additional planned stops (or other geolocations) along the route. Inputs 900 may also include player parameters 905 related to the people playing the in-vehicle game, including age and other demographic characteristics, game genre preferences, etc. The inputs 900 may further include vehicle parameters 910 such as vehicle fuel/charge range, vehicle type (some vehicles known to be more fuel or charge-efficient than others), etc.

What's more, the inputs 900 may include a parameter 915 related to whether the goal of the trip—complemented by the game media—is to arrive as soon as possible (hence less game content being needed) or to lengthen the trip as appropriate to present added game content along the way to enhance gameplay with an extended storyline afforded by the extra driving time.

The inputs 900 may also include route data and metadata 919 from a map/route finding app 917. Again this may include the predetermined route, landmarks along the route, etc.

The inputs/parameters 900 may then be provided to an LLM and other AI models 920, including those set forth above with respect to FIG. 7 and elsewhere. The models 920 may then be used as set forth above to generate a game play story with objectives and roles for some or all vehicle participants. Thus, the LLM may output a game story board 930 (more generally, a storyline) incorporating aspects of the real-world trip itself, such as key points along the route and any potential stops, personal parameters related to the players themselves, etc. Also note that the game story board 930 may change based on polling update data 935, including environmental factors 940 such as different kinds of weather that might affect driving time as well as game objects that may be used based on the current or expected weather. The story board 930 may then be provided to additional generative AI models 950, such as generative video, audio, and game code models for purposes set forth above.

Accordingly, the AI models 950 may output AR graphics 955 for each display (window) of the vehicle that is to be used for the game, objectives and scoring metrics 960 for the game (e.g., as provided by the LLM), and generative game audio 965. The game media 955-965 may then be output to the players over the vehicle's electronic entertainment system as set forth herein.

While the particular embodiments are herein shown and described in detail, it is to be understood that the subject matter which is encompassed by the present application is limited only by the claims.

What is claimed is:

1. An apparatus, comprising:
at least one processor system configured to:
access first data related to navigation from a first geolocation to a second geolocation;
provide the first data to a large language model (LLM) along with a prompt to generate a storyline using the first data;
receive, from the LLM, an output indicating the storyline; and
present audio related to the storyline via a vehicle's audio system.

2. The apparatus of claim 1, wherein the storyline is an interactive storyline.

3. The apparatus of claim 2, wherein the at least one processor system is configured to:
receive first audible input; and
present, based on the first audible input, a first aspect of the storyline as part of the audio.

4. The apparatus of claim 3, wherein the at least one processor system is configured to:
receive second audible input; and
present, based on the second audible input, a second aspect of the storyline as part of the audio, the second aspect being different from the first aspect, the second aspect presented as part of the audio instead of a third aspect of the storyline also indicated in the output from the LLM, the second aspect of the storyline being presented in the alternative to the third aspect of the storyline based on the substance of the second audible input.

5. The apparatus of claim 1, wherein the at least one processor system is configured to:
present video related to the storyline via the vehicle's video system.

6. The apparatus of claim 5, wherein the storyline is an interactive storyline that is used by the at least one processor system to present both interactive audio and interactive video at the vehicle.

7. The apparatus of claim 6, wherein the interactive video is presented on one or more displays integrated into respective windows of the vehicle.

8. The apparatus of claim 7, wherein the respective windows of the vehicle comprise one or more of: a windshield of the vehicle, a side window of the vehicle, a rear window of the vehicle.

9. The apparatus of claim 1, wherein the first data is related to one or more geographic features located along a route from the first geolocation to the second geolocation.

10. The apparatus of claim 1, wherein the first data is related to one or more of: a fuel range of the vehicle while navigating from the first geolocation to the second geolocation, an electric charge range of the vehicle while navigating from the first geolocation to the second geolocation.

11. The apparatus of claim 1, wherein the first data is related to forecasted weather along a route from the first geolocation to the second geolocation.

12. The apparatus of claim 1, wherein the at least one processor system is configured to:
receive user input to detour from a route from the first geolocation to the second geolocation; and
based on the user input, change the presentation of the audio related to the storyline.

13. A method, comprising:
accessing first data related to vehicle travel from a first geolocation to a second geolocation;
providing the first data to a model;
providing a prompt to the model to generate a storyline using the first data;
receiving, from the model, an output indicating the storyline; and
presenting media related to the storyline via an output device.

14. The method of claim 13, wherein the model comprises a large language model (LLM).

15. The method of claim 13, wherein the output device comprises a vehicle audio system.

16. The method of claim 15, wherein the output device comprises a vehicle video system.

17. The method of claim 13, wherein the media is first media that is interactive, and wherein the method comprises:
receiving user input;
processing the user input to identify second media that is interactive, the second media also related to the storyline; and
based on the identification of the second media, presenting the second media via the output device.

18. An apparatus, comprising:
at least one computer readable storage medium (CRSM) that is not a transitory signal, the at least one CRSM comprising instructions executable by a processor system to:
access first data related to vehicle travel from a first geolocation to a second geolocation;
provide the first data to a model;
provide a prompt to the model to generate a storyline using the first data;
receive, from the model, an output indicating the storyline; and
present media related to the storyline via an output device.

19. The apparatus of claim 18, wherein the media is first media, and wherein the instructions are executable to:
receive user input to add a stop to a route being traversed by the vehicle, the route being from the first geographic location to the second geographic location;
based on the user input, access added content for the storyline; and
present second media at the output device, the second media related to the added content.

20. The apparatus of claim 18, wherein the media comprises interactive audio video content that establishes an electronic game that is playable by passengers in a vehicle in which the media is presented, the output device established by the vehicle.
